(19) United States
(12) Patent Application Publication
(10) Pub. No.: US 2021/0243710 A1
(43) Pub. Date: Aug. 5, 2021

(54) SIGNAL TRANSMISSION METHOD, TRANSMITTING TERMINAL DEVICE, AND RECEIVING TERMINAL DEVICE

(71) Applicant: GUANGDONG OPPO MOBILE TELECOMMUNICATIONS CORP., LTD., Dongguan (CN)

(72) Inventor: Hai Tang, Dongguan (CN)

(21) Appl. No.: 17/235,797

(22) Filed: Apr. 20, 2021

Related U.S. Application Data
(63) Continuation of application No. PCT/CN2018/112271, filed on Oct. 27, 2018.

(51) Int. Cl. H04W 56/00; H04L 1/16

(52) U.S. Cl. CPC H04W 56/006; H04L 1/1614; H04W 56/001

(57) ABSTRACT

A signal transmission method, a transmitting terminal device and a receiving terminal device are provided. The transmitting terminal device may use a small bitmap to indicate the position of an SSB actually transmitted within a transmission window of a DRS. The method includes that a transmitting terminal device respectively sends first indication information consisting of M1 bits and second indication information consisting of M2 bits to the receiving terminal device, the first indication information and the second indication information being used for indicating a position index of an SSB actually transmitted within a first transmission window, herein the first transmission window includes candidate transmission positions of Y SSBs, at most X SSBs are capable of being transmitted within the first transmission window, X is a positive integer less than or equal to 8, Y is a positive integer greater than X, and M1 and M2 are positive integers.

### CROSS-REFERENCE TO RELATED APPLICATION(S)

This application is a continuation application of International Application No. PCT/CN2018/112271 filed on Oct. 27, 2018, of which the entire disclosure is hereby incorporated by reference.

### TECHNICAL FIELD

Implementations of the present disclosure relate to the field of communication, and more particularly, to a signal transmission method, a transmitting end device, and a receiving end device.

### BACKGROUND

In a 5-Generation New Radio (5G NR) system, for frequency bands below 6 GHz, there are at most 8 indexes of Synchronization Signal/Physical Broadcast Channel blocks (SSB). A network device may inform a terminal device of specific SSB transmission positions through an 8-bit bitmap based on broadcasting. Each bit represents whether one SSB is sent or not for the terminal device to perform rate matching. For frequency bands above 6 GHz, there are at most 64 indexes of SSBs, and a network device may inform a terminal device of specific SSB transmission positions through a 16-bit bitmap based on broadcasting.

When the 5G NR system is applied to an unlicensed spectrum, many candidate SSB transmission positions may be used in a transmission window of a Discovery Reference Signal (DRS). How to indicate actual transmission positions of SSBs among these candidate SSB transmission positions is an urgent problem to be solved.

### SUMMARY

Implementations of the present disclosure provide a signal transmission method, a transmitting end device and a receiving end device, wherein the transmitting end device may use a small bitmap to indicate a position of an SSB actually transmitted within a DRS transmission window for the receiving end device.

In a first aspect, a signal transmission method is provided, which includes that a transmitting end device sends first indication information consisting of M1 bits and second indication information consisting of M2 bits to a receiving end device, respectively. The first indication information and the second indication information are used for indicating a position index of an SSB actually transmitted within a first transmission window, herein the first transmission window includes Y candidate SSB transmission positions, and at most X SSBs are capable of being transmitted within the first transmission window, X is a positive integer less than or equal to 8, Y is a positive integer greater than X, and M1 and M2 are positive integers.

Optionally, the transmitting end device may be a network device, and the receiving end device may be a terminal device.

Optionally, when the method is applied to D2D or V2X, the transmitting end device may be a first terminal device and the receiving end device may be a second terminal device.

Optionally, the first transmission window is a discovery reference signal transmission window, which is one of at least one discovery reference signal transmission window in one discovery reference signal period.

In a second aspect, a signal transmission method is provided, which includes that a receiving end device receives first indication information consisting of M1 bits and second indication information consisting of M2 bits sent by a transmitting end device, respectively. The first indication information and the second indication information are used for indicating a position index of an SSB actually transmitted within a first transmission window, herein the first transmission window includes Y candidate SSB transmission positions, and at most X SSBs are capable of being transmitted within the first transmission window, X is a positive integer less than or equal to 8, Y is a positive integer greater than X, and M1 and M2 are positive integers; and the receiving end device determines the position index of the SSB actually transmitted within the first transmission window according to the first indication information and the second indication information, and determine a position for receiving an SSB sent by the transmitting end device.

It should be understood that the receiving end device may determine the position of the SSB sent by the transmitting end device, after determining the position index of the SSB actually transmitted within the first transmission window.

Optionally, the transmitting end device may be a network device, and the receiving end device may be a terminal device.

Optionally, when the method is applied to D2D or V2X, the transmitting end device may be a first terminal device and the receiving end device may be a second terminal device.

Optionally, the first transmission window is a discovery reference signal transmission window, which is one of at least one discovery reference signal transmission window in one discovery reference signal period.

In a third aspect, a transmitting end device is provided, which is configured to perform the method in the first aspect or various implementations thereof.

Specifically, the transmitting end device includes functional modules configured to perform the method in the first aspect.

In a fourth aspect, a receiving end device is provided, which is configured to perform the method in the second aspect or various implementations thereof.

Specifically, the receiving end device includes functional modules, configured to perform the method in the second aspect.

In a fifth aspect, a transmitting end device is provided, which includes a processor and a memory. The memory is configured to store a computer program, and the processor is configured to call and run the computer program stored in the memory to perform the method in the first aspect.

In a sixth aspect, a receiving end device is provided, which includes a processor and a memory. The memory is configured to store a computer program, and the processor is configured to call and run the computer program stored in the memory to perform the method in the second aspect.

In a seventh aspect, a chip is provided, which is configured to implement the method in any one of the first to second aspects.

Specifically, the chip includes a processor for calling and running a computer program from a memory, to enable a device mounted with the chip to perform the method in any one of the first to second aspects or various implementations thereof.

In an eighth aspect, a computer-readable storage medium is provided, which is configured to store a computer program that enables a computer to perform the method in any one of the first to second aspects.

In a ninth aspect, a computer program product is provided, which includes computer program instructions that enable a computer to perform the method in any one of the first to second aspects.

In a tenth aspect, a computer program is provided. When being run on a computer, the computer program enables the computer to perform the method in any one of the first to second aspects.

### BRIEF DESCRIPTION OF DRAWINGS

FIG. 1 is a schematic diagram of an architecture of a communication system according to an implementation of the present disclosure.

FIG. 2 is a schematic flow chart of a signal transmission method according to an implementation of the present disclosure.

FIG. 3 is a schematic diagram of SSB transmission according to an implementation of the present disclosure.

FIG. 4 is a schematic diagram of another SSB transmission according to an implementation of the present disclosure.

FIG. 5 is a schematic diagram of a further SSB transmission according to an implementation of the present disclosure.

FIG. 6 is a schematic diagram of a still further SSB transmission according to an implementation of the present disclosure.

FIG. 7 is a schematic diagram of a still further SSB transmission according to an implementation of the present disclosure.

FIG. 8 is a schematic diagram of a still further SSB transmission according to an implementation of the present disclosure.

FIG. 9 is a schematic diagram of a still further SSB transmission according to an implementation of the present disclosure.

FIG. 10 is a schematic flow chart of another signal transmission method according to an implementation of the present disclosure.

FIG. 11 is a schematic block diagram of a transmitting end device according to an implementation of the present disclosure.

FIG. 12 is a schematic block diagram of a receiving end device according to an implementation of the present disclosure.

FIG. 13 is a schematic block diagram of a communication device according to an implementation of the present disclosure.

FIG. 14 is a schematic block diagram of a chip according to an implementation of the present disclosure.

FIG. 15 is a schematic block diagram of a communication system according to an implementation of the present disclosure.

### DETAILED DESCRIPTION

Technical solutions in implementations of the present disclosure will be described below with reference to the drawings in the implementations of the present disclosure. It is apparent that the implementations described are just some implementations of the present disclosure, but not all implementations of the present disclosure. According to the implementations of the present disclosure, all other implementations achieved by a person of ordinary skills in the art without paying an inventive effort are within the protection scope of the present disclosure.

The implementations of the present disclosure may be applied to various communication systems, such as a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced long term evolution (LTE-A) system, a New Radio (NR) system, an evolution system of an NR system, a LTE-based access to unlicensed spectrum (LTE-U) system, an NR-based access to unlicensed spectrum (NR-U) system, a Universal Mobile Telecommunication System (UMTS), a Wireless Local Area Network (WLAN), Wireless Fidelity (WiFi), a next-generation communication system or other communication systems, etc.

Generally speaking, a traditional communication system supports a limited quantity of connections, which is also easy to implement. However, with the development of communication technology, a mobile communication system will not only support traditional communication, but also support, for example, Device to Device (D2D) communication, Machine to Machine (M2M) communication, Machine Type Communication (MTC), Vehicle to Vehicle (V2V) communication, etc. The implementations of the present disclosure may also be applied to these communication systems.

Optionally, a communication system in an implementation of the present disclosure may be applied to a Carrier Aggregation (CA) scenario, may also be applied to a Dual Connectivity (DC) scenario, and may also be applied to a Standalone (SA) network deployment scenario.

A spectrum used is not limited in the implementations of the present disclosure. For example, the implementations of the present disclosure may be applied to a licensed spectrum, and may also be applied to an unlicensed spectrum.

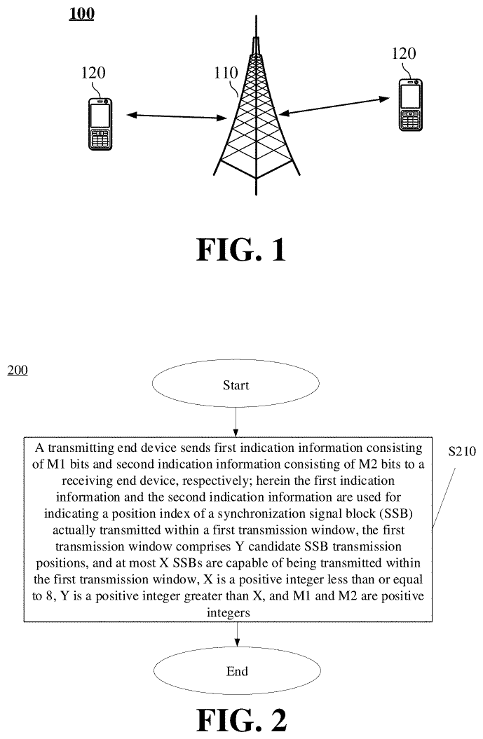

Illustratively, a communication system 100 to which an implementation of the present disclosure is applied as shown in FIG. 1. The communication system 100 may include a network device 110, and the network device 110 may be a device that communicates with a terminal device 120 (or referred to as a communication terminal, or a terminal). The network device 110 may provide communication coverage for a specific geographical area, and may communicate with terminal devices located within the coverage area.

FIG. 1 shows one network device and two terminal devices as an example. Optionally, the communication system 100 may include multiple network devices, and other quantities of terminal devices may be included within the coverage area of each network device, which is not limited in the implementations of the present disclosure.

Optionally, the communication system 100 may further include other network entities such as a network controller and a mobile management entity, which is not limited in the implementations of the present disclosure.

It should be understood that devices with communication function in a network/system may be referred to as communication devices in the implementations of the present disclosure. Taking the communication system 100 shown in FIG. 1 as an example, communication devices may include a network device 110 and a terminal device 120 which have communication function, and the network device 110 and the terminal device 120 may be the specific devices described above, which will not be described here again. The communication devices may also include other devices in the communication system 100, e.g., other network entities such as a network controller and a mobile management entity, which is not limited in the implementations of the present disclosure.

In the implementations of the present disclosure, each implementation is described in connection with a terminal device and a network device. The terminal device may also be referred to a User Equipment (UE), an access terminal, a subscriber unit, a subscriber station, a mobile station, a remote platform, a remote station, a remote terminal, a mobile device, a user terminal, a terminal, a wireless communication device, a user agent, a user apparatus, etc. The terminal device may be a station (ST) in a WLAN, or may be a cellular phone, a cordless phone, a Session Initiation Protocol (SIP) phone, a Wireless Local Loop (WLL) station, a Personal Digital Assistant (PDA) device, a handheld device or a computing device with a wireless communication function, or other processing device connected to a wireless modem, a vehicle-mounted device, a wearable device, and a next generation communication system, such as a terminal device in an NR network, or a terminal device in a future evolved Public Land Mobile Network (PLMN) network, etc.

As an example but not a limitation, in the implementations of the present disclosure, the terminal device may also be a wearable device. A wearable device may also be referred to a wearable intelligent device, which is a general term of wearable devices developed by intelligent design of daily wear using wearing technology, e.g., glasses, gloves, watches, clothing, shoes, etc. A wearable device is a portable device that is worn directly on a body or integrated into the clothes or accessories of a user. A wearable device is not only a hardware device, but also a device capable of realizing powerful functions through software support, data interaction and cloud interaction. In a broad sense, a wearable intelligent device includes a device that is full-featured and large-sized and may realize complete or partial functions without relying on a smart phone, e.g., a smart watch, a smart glasses, etc., and a device that is only focused on a certain type of application functions and need to be used in cooperation with other device such as a smart phone, e.g., a smart bracelet, a smart jewelry, etc. for various physical signs monitoring.

A network device may be a device for communicating with a mobile device, or may be an Access Point (AP) in the WLAN, or a Base Transceiver Station (BTS) in GSM or CDMA, or may be a NodeB (NB) in WCDMA, or an Evolutional Node B (eNB or eNodeB) in LTE, or a relay station or an access point, or a vehicle-mounted device, a wearable device, a gNB in an NR network, or a network device in the future evolved PLMN network, etc.

In the implementations of the present disclosure, a network device provides services for a cell, and a terminal device communicates with the network device through transmission resources (e.g., frequency domain resources or spectrum resources) used by the cell. The cell may be a cell corresponding to the network device (e.g., base station), and the cell may belong to a macro base station, or a base station corresponding to a small cell. The small cell here may include: a Metro cell, a Micro cell, a Pico cell, a Femto cell, etc. These small cells have the characteristics of small coverage and low transmission power, and are suitable for providing high-speed data transmission services.

It should be understood that in the research of a 5G unlicensed spectrum, as channel sensing on an unlicensed spectrum needs to be performed based on Listen Before Talk (LBT) before using a channel for signal transmission, uncertainty of utilization time of a channel will be caused by LBT. At present, many candidate SSB transmission positions are used in a DRS transmission window in frequency bands below 7 GHz, and a corresponding problem is how to indicate an actual SSB transmission position among these candidate SSB transmission positions, for UE to perform rate matching, etc. In the present patent, by designing a specific bitmap indication mechanism, a position of an SSB actually transmitted is indicated within a DRS period using a small bitmap for a terminal device to perform rate matching, etc.

FIG. 2 is a schematic flow chart of a signal transmission method 200 according to an implementation of the present disclosure. As shown in FIG. 2, the method 200 may include act S210.

In act S210, a transmitting end device sends first indication information consisting of M1 bits and second indication information consisting of M2 bits to a receiving end device, respectively. The first indication information and the second indication information are used for indicating a position index of a Synchronization Signal Block (SSB) actually transmitted within a first transmission window. Herein the first transmission window includes Y candidate SSB transmission positions, and at most X SSBs are capable of being transmitted within the first transmission window, X is a positive integer less than or equal to 8, Y is a positive integer greater than X, and M1 and M2 are positive integers.

Optionally, when the method is applied to a communication system as shown in FIG. 1, the transmitting end device may be a network device, and the receiving end device may be a terminal device. When the method is applied to D2D or V2X, the transmitting end device may be a first terminal device, the receiving end device may be a second terminal device, and the first terminal device communicates with the second terminal device through D2D or V2X.

Description is made below by taking the method being applied to the communication system shown in FIG. 1 as an example.

Optionally, in an implementation of the present disclosure, the first transmission window is a discovery reference signal transmission window, and the first transmission window is one of at least one discovery reference signal transmission window in one discovery reference signal period.

It should be understood that there may be at least one discovery reference signal transmission window within one discovery reference signal (DRS) period. For example, one DRS period is 80 ms, and there may be multiple 10 ms DRS transmission windows in this DRS period.

It should be noted that the first indication information and the second indication information are combined to indicate a position index of an SSB actually transmitted in the first transmission window.

Optionally, the first transmission window may be a resource on an unlicensed spectrum.

Optionally, in an implementation of the present disclosure, the Y candidate SSB transmission positions may be divided into N1 SSB groups, and each SSB group includes N2 candidate SSB transmission positions, N1 and N2 being positive integers.

Optionally, in an implementation of the present disclosure, the transmitting end device may directly indicate an SSB group in which a first SSB actually transmitted is located. Preferably, the transmitting end device sends third indication information consisting of M3 bits to the receiving end device. The third indication information is used for indicating a first SSB group. The first SSB group is an SSB group in which the first SSB actually transmitted is located. At this time, the receiving end device may determine, based on the third indication information, from which SSB group the transmitting end device starts to transmit an SSB.

Specifically, the transmitting end device sends the third indication information to the receiving end device through one of broadcasting, Downlink Control Information (DCI) and Radio Resource Control (RRC) signaling.

For example, the transmitting end device sends the third indication information to the receiving end device through a broadcast System Information Block 1 (SIB1), i.e., the third indication information is carried in the SIB1.

Optionally, M3=log₂ N1 or M3=┌log₂ N1┐, wherein ┌ ┐ means rounding up.

Optionally, in an implementation of the present disclosure, the receiving end device may also determine, based on a detected SSB index, from which SSB group the transmitting end device starts to transmit an SSB.

Optionally, in an implementation of the present disclosure, the first indication information and the second indication information may specifically indicate a position index of an SSB actually transmitted within the first transmission window in a mode of the following examples.

Example one: the first indication information indicates, with an M1-bit bitmap, a number of SSBs and position indexes of the SSBs actually transmitted in the first SSB group and the second SSB group, and the second indication information indicates, with M2 bits, that a first SSB actually transmitted is located at a k-th candidate SSB transmission position in the first SSB group. The second SSB group is a next group of the first SSB group, and k is a positive integer less than or equal to N2.

Optionally, in the example one, if M1=N2, the first indication information specifically indicates, with an M1-bit bitmap, a number of SSBs and position indexes of the SSBs actually transmitted at a k-th to an N2-th candidate SSB transmission positions in the first SSB group, and a number of SSBs and position indexes of the SSBs actually transmitted at a first to a (k−1)-th candidate SSB transmission positions in the second SSB group.

Further, in the example one, if M1=N2, the first indication information specifically indicates the number of the SSBs and the position indexes of the SSBs actually transmitted at the k-th to the N2-th candidate SSB transmission positions in the first SSB group with a k-th to an M1-th bits in the M1-bit bitmap, and indicates the number of the SSBs and the position indexes of the SSBs actually transmitted at the first to the (k−1)-th candidate SSB transmission positions in the second SSB group with a first to a (k−1)-th bits in the M1-bit bitmap.

Furthermore, in the example one, if M1=N2 and k=1, the first indication information specifically indicates the number of the SSBs and the position indexes of the SSBs actually transmitted at the first to the N2-th candidate SSB transmission positions in the first SSB group with the first to the M1-th bits in the M1-bit bitmap.

Optionally, in the example one, if M1=N2−1, the first indication information includes a first subsection and a second subsection. The first subsection consists of a k-th to an M1-th bits in the first indication information, and the second subsection consists of a first to a (k−1)-th bits in the first indication information. A bitmap of the first subsection indicates a number of SSBs and position indexes of the SSBs actually transmitted at a (k+1)-th to an N2-th candidate SSB transmission positions in the first SSB group; and a bitmap of the second subsection indicates a number of SSBs and position indexes of the SSBs actually transmitted at a first to a (k−1)-th candidate SSB transmission positions in the second SSB group.

Further, in the example one, if M1=N2−1 and k=1, the bitmap of the first subsection specifically indicates the number of the SSBs and the position indexes of the SSBs actually transmitted at the second to the N2-th candidate SSB transmission positions in the first SSB group.

Optionally, in the example one, M2=log₂ N2.

Optionally, in the example one, the first SSB group is indicated by the third indication information.

Optionally, in the example one, the receiving end device may determine the first SSB group based on a detected SSB index.

Example two: the first indication information indicates, with an M1-bit bitmap, a number of SSBs and position indexes of the SSBs actually transmitted at M1 candidate SSB transmission positions starting from a candidate SSB transmission position at which a first SSB actually transmitted is located, and the second indication information indicates, with M2 bits, that the first SSB actually transmitted is located at a k-th candidate SSB transmission position in the first SSB group, M1=N2 and k being a positive integer less than or equal to N2.

Optionally, in the example two, M2=log₂ N2.

Optionally, in the example two, the first SSB group is indicated by the third indication information.

Optionally, in the example two, the receiving end device may determine the first SSB group based on a detected SSB index.

Example three: the first indication information indicates, with an M1-bit bitmap, a number of SSBs and position indexes of the SSBs actually transmitted at M1 candidate SSB transmission positions after a candidate SSB transmission position at which a first SSB actually transmitted is located, and the second indication information indicates, with M2 bits, that the first SSB actually transmitted is located at a k-th candidate SSB transmission position in the first SSB group, M1=N2−1 and k being a positive integer less than or equal to N2.

Optionally, in the example three, M2=log₂ N2.

Optionally, in the example three, the first SSB group is indicated by the third indication information.

Optionally, in the example three, the receiving end device may determine the first SSB group based on a detected SSB index.

Example four: the first indication information indicates a number of SSBs actually transmitted with M1 bits, and the SSBs actually transmitted occupy continuous candidate SSB transmission positions; and the second indication information indicates that a first SSB actually transmitted is located at a k-th candidate SSB transmission position in the first SSB group with M2 bits, k being a positive integer less than or equal to N2.

Optionally, in the example four, M1=log₂ X.

Optionally, in the example four, M2=log₂ N2.

Optionally, in the example four, the first SSB group is indicated by the third indication information.

Optionally, in the example four, the receiving end device may determine the first SSB group based on a detected SSB index.

Example five: the first indication information indicates, with an M1-bit bitmap, a number of SSBs and position indexes of the SSBs actually transmitted at M1 candidate SSB transmission positions before a candidate SSB transmission position at which an SSB currently transmitted is located, and the second indication information indicates, with an M2-bit bitmap, a number of SSBs and position indexes of the SSBs actually transmitted at M2 candidate SSB transmission positions after the candidate SSB transmission position at which the SSB currently transmitted is located.

Optionally, in the example five, M1=M2=N2−1.

It should be noted that in the example five, the receiving end device may detect the SSB currently transmitted.

Example six: the first indication information indicates a number of SSBs continuously transmitted before a candidate SSB transmission position at which an SSB currently transmitted is located with M1 bits, including the SSB currently transmitted; and the second indication information indicates a number of SSBs continuously transmitted after the candidate SSB transmission position at which the SSB currently transmitted is located with M2 bits, including the SSB currently transmitted.

Optionally, in the example six, M1=M2=log₂ X.

It should be noted that in the example six, the receiving end device may detect the SSB currently transmitted.

Optionally, in an implementation of the present disclosure, values of Y, N1 and N2 may be as follows:

Y is 16, N1 is 4, and N2 is 4; or Y is 16, N1 is 2, and N2 is 8; or Y is 32, N1 is 8, and N2 is 4; or Y is 32, N1 is 4, and N2 is 8; or Y is 32, N1 is 2, and N2 is 16; or Y is 64, N1 is 16, and N2 is 4; or Y is 64, N1 is 8, and N2 is 8; or Y is 64, N1 is 4, and N2 is 16; or Y is 64, N1 is 2, and N2 is 32.

Optionally, in an implementation of the present disclosure, X is 8, or X is 4.

Optionally, in an implementation of the present disclosure, the transmitting end device may send the first indication information to the receiving end device through one of broadcasting, DCI, or RRC signaling. For example, the transmitting end device sends the first indication information to the receiving end device through a broadcast SIB1.

Optionally, in an implementation of the present disclosure, the transmitting end device may send the second indication information to the receiving end device through one of broadcasting, DCI, or RRC signaling. For example, the transmitting end device sends the second indication information to the receiving end device through DCI.

Optionally, in an implementation of the present disclosure, the first indication information and the second indication information may be integrated in one piece of information for transmission, for example, through a broadcast SIB1. Optionally, in an implementation of the present disclosure, the second indication information and the third indication information may be integrated in one piece of information for transmission, for example, through DCI. Optionally, in an implementation of the present disclosure, the first indication information, the second indication information and the third indication information may be integrated in one piece of information for transmission, and a transmission mode may be any one of broadcasting, DCI, or RRC signaling.

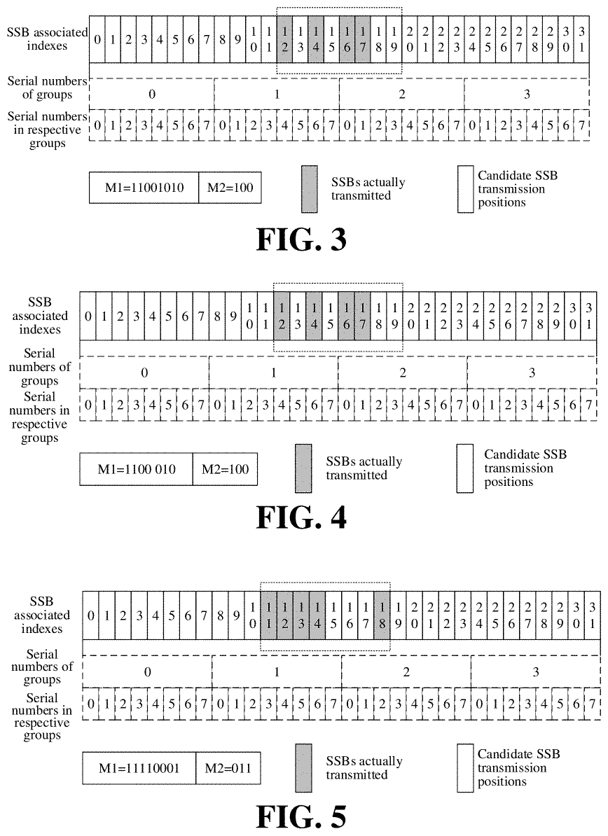

Below, a signal transmission method 200 according to an implementation of the present disclosure will be described in detail with reference to FIGS. 3 to 9. Specifically, detailed description may be made corresponding to implementations one to seven respectively. In the implementations one to seven, taking the transmitting end device being a base station and the receiving end device being a UE as an example for specific description, and in which a case where Y=32, X=8, and SSB associated indexes are 0-31, N1=4 and N2=8 is taken as an example.

Optionally, as implementation one, a first transmission window includes four SSB groups which are SSB group 0 to SSB group 3 as shown in FIG. 3. Each SSB group includes 8 candidate SSB transmission positions, which are candidate SSB transmission position 0 to candidate SSB transmission position 7. The first indication information consists of M1=8 bits, and the second indication information consists of M2=3 bits. Specifically, the first indication information indicates a number of SSBs and position indexes of the SSBs actually transmitted at a k-th to an N2-th candidate SSB transmission positions in the first SSB group with a k-th to an M1-th bits in a M1-bit bitmap, and indicates a number of SSBs and position indexes of the SSBs actually transmitted at a first to a (k−1)-th candidate SSB transmission positions in the second SSB group with a first to a (k−1)-th bits in an M1-bit bitmap; and the second indication information indicates that a first SSB actually transmitted is located at a k-th candidate SSB transmission position in the first SSB group with 3 bits.

It should be noted that when a bit in the 8-bit bitmap used by the first indication information is set to “1”, an SSB is transmitted at a candidate SSB transmission position corresponding to the bit among the 8 candidate SSB transmission positions in the group. For example, when a second bit in the 8-bit bitmap is set to “1”, an SSB is transmitted at a second candidate SSB transmission position among the candidate SSB transmission positions in the group.

In the implementation one, the first SSB group is an SSB group in which the first SSB actually transmitted is located, and the second SSB group is the next group of the first SSB group.

Optionally, the first SSB group may be indicated by a base station. For example, the base station may send third indication information indicating the first SSB group to a UE through one of broadcasting, DCI, or RRC signaling.

Optionally, the first SSB group may also be determined by a UE based on a detected SSB index.

Specifically, as shown in FIG. 3, the first SSB group is SSB group 1, and the second SSB group is SSB group 2.

It should be noted that from which SSB group the base station starts to transmit an SSB depends on a configuration of the base station. For example, in an unlicensed frequency band, the base station may transmit an SSB at a first candidate SSB transmission position after obtaining an available channel.

Specifically, as shown in FIG. 3, M2=100, which indicates that the first SSB actually transmitted is located at a 5th candidate SSB transmission position in SSB group 1, i.e., k=5, and a corresponding SSB position index is 12.

It should be noted that 000 corresponds to k being 1, 001 corresponds to k being 2, and so on, and 111 corresponds to k being 8.

Specifically, as shown in FIG. 3, M1=11001010, and a 5th to an 8th bits in M1 indicate that a number of SSBs actually transmitted at a 5th to an 8th candidate SSB transmission positions in SSB group 1 is 2, and position indexes of the SSBs actually transmitted are 12 and 14; and a first to a 4th bits in M1 indicate that a number of SSBs actually transmitted at a first to a 4th candidate SSB transmission positions in SSB group 2 is 2, and position indexes of the SSBs actually transmitted are 16 and 17.

Optionally, in the implementation one, the UE may determine, just based on M1 and M2, positions of SSBs actually transmitted by the base station within the first transmission window.

Optionally, as an implementation two, a first transmission window includes four SSB groups which are SSB group 0 to SSB group 3 as shown in FIG. 4. Each SSB group includes 8 candidate SSB transmission positions, which are candidate SSB transmission position 0 to candidate SSB transmission position 7. The first indication information consists of M1=7 bits, and the second indication information consists of M2=3 bits. Specifically, the first indication information includes a first subsection and a second subsection. The first subsection consists of a k-th to a 7th bits in the first indication information, and the second subsection consists of a first to a (k−1)-th bits in the first indication information. A bitmap of the first subsection indicates a number of SSBs and position indexes of the SSBs actually transmitted at a (k+1)-th to an N2-th candidate SSB transmission positions in the first SSB group, and a bitmap of the second subsection indicates a number of SSBs and position indexes of the SSBs actually transmitted at a first to a (k−1)-th candidate SSB transmission positions in the second SSB group. The second indication information indicates that the first SSB actually transmitted is located at a k-th candidate SSB transmission position in the first SSB group with 3 bits.

It should be noted that when a bit in a 7-bit bitmap used by the first indication information is set to “1”, an SSB is transmitted at a candidate SSB transmission position corresponding to the bit.

In the implementation two, the first SSB group is an SSB group in which the first SSB actually transmitted is located, and the second SSB group is the next group of the first SSB group.

Optionally, the first SSB group may be indicated by a base station. For example, the base station may send third indication information indicating the first SSB group to the UE through one of broadcasting, DCI, or RRC signaling.

Optionally, the first SSB group may also be determined by the UE based on a detected SSB index.

Specifically, as shown in FIG. 4, the first SSB group is SSB group 1, and the second SSB group is SSB group 2.

It should be noted that from which SSB group the base station starts to transmit an SSB depends on a configuration of the base station. For example, in an unlicensed frequency band, the base station may transmit an SSB at a first candidate SSB transmission position after obtaining an available channel.

Specifically, as shown in FIG. 4, M2=100, which indicates that the first SSB actually transmitted is located at a 5th candidate SSB transmission position in SSB group 1, i.e., k=5, and a corresponding SSB position index is 12. It should be noted that 000 corresponds to k being 1, 001 corresponds to k being 2, and so on, and 111 corresponds to k being 8.

Specifically, as shown in FIG. 4, M1=1100010, the first subsection consists of a 5th to a 7th bits in M1, i.e., the first subsection=010. The first subsection indicates that a number of SSBs actually transmitted at a 6th to an 8th candidate SSB transmission positions in SSB group 1 is 1, and a position index of the SSB actually transmitted is 14. The second subsection consists of a first to a 4th bits in M1, i.e., the second subsection=1100. The second subsection indicates that a number of SSBs actually transmitted at a first to a 4th candidate SSB transmission positions in SSB group 2 is 2, and position indexes of the SSBs actually transmitted are 16 and 17.

Optionally, in the implementation two, the UE may determine, just based on M1 and M2, positions of SSBs actually transmitted by the base station within the first transmission window.

Optionally, as an implementation three, the first transmission window includes four SSB groups, which are SSB group 0 to SSB group 3 as shown in FIG. 5. Each SSB group includes 8 candidate SSB transmission positions, which are candidate SSB transmission position 0 to candidate SSB transmission position 7. The first indication information consists of M1=8 bits, and the second indication information consists of M2=3 bits. Specifically, the first indication information indicates, with an 8-bit bitmap, a number of SSBs and position indexes of the SSBs actually transmitted at 8 candidate SSB transmission positions starting from a candidate SSB transmission position at which the first SSB actually transmitted is located, and the second indication information indicates, with 3 bits, that a first SSB actually transmitted is located at a k-th candidate SSB transmission position in the first SSB group.

It should be noted that the first indication information indicates, with the 8-bit bitmap, the number of the SSBs and the position indexes of the SSBs actually transmitted at the 8 candidate SSB transmission positions starting from the candidate SSB transmission position at which the first SSB actually transmitted by the base station is located. For example, when the 8-bit bitmap is set to “11110001”, an SSB transmission situation at the 8 candidate SSB transmission positions starting from the candidate SSB transmission position at which the first SSB actually transmitted by the base station is located is as follows: first, there are SSB transmissions at four continuous candidate SSB transmission positions, then there are no SSB transmissions at three candidate SSB transmission positions, and then there is a further SSB transmission at a candidate SSB transmission position.

In the implementation three, the first SSB group is an SSB group in which the first SSB actually transmitted is located.

Optionally, the first SSB group may be indicated by a base station. For example, the base station may send third indication information indicating the first SSB group to the UE through one of broadcasting, DCI, or RRC signaling. Optionally, the first SSB group may also be determined by the UE based on a detected SSB index. Specifically, as shown in FIG. 5, the first SSB group is SSB group 1.

It should be noted that from which SSB group the base station starts to transmit an SSB depends on a configuration of the base station. For example, in an unlicensed frequency band, the base station may transmit an SSB at a first candidate SSB transmission position after obtaining an available channel.

Specifically, as shown in FIG. 5, M2=011, which indicates that the first SSB actually transmitted is located at a 4th candidate SSB transmission position in SSB group 1, i.e., k=4, and a corresponding SSB position index is 11. It should be noted that 000 corresponds to k being 1, 001 corresponds to k being 2, and so on, and 111 corresponds to k being 8.

Specifically, as shown in FIG. 5, M1=11110001, and the first indication information indicates, with a 8-bit bitmap, that the number of the SSBs actually transmitted at the 8 candidate SSB transmission positions starting from a candidate SSB transmission position at which the first SSB actually transmitted is located is 5, and the position indexes of the SSBs are 11, 12, 13, 14 and 18.

Optionally, in the implementation three, the UE may determine, just based on M1 and M2, positions of SSBs actually transmitted by the base station within the first transmission window.

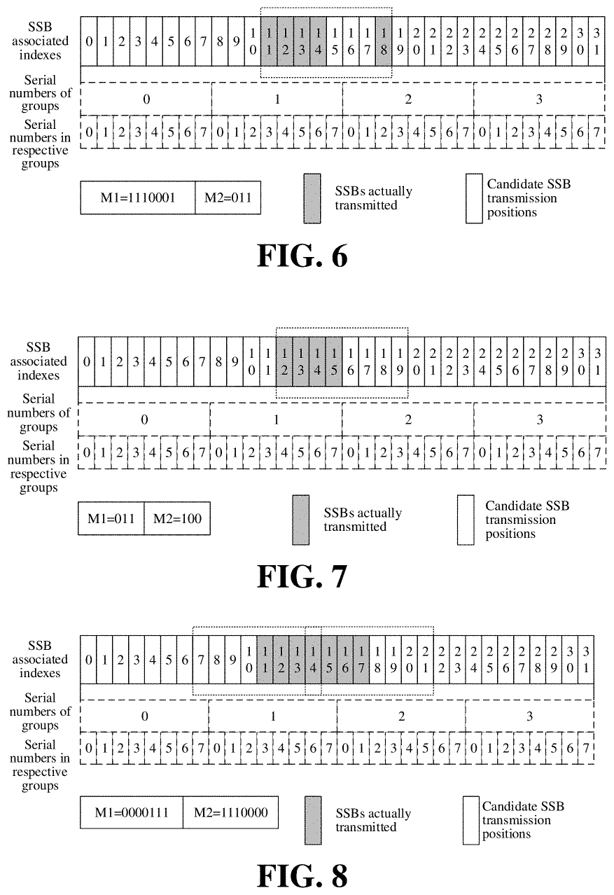

Optionally, as an implementation four, the first transmission window includes four SSB groups, which are SSB group 0 to SSB group 3 as shown in FIG. 6. Each SSB group includes 8 candidate SSB transmission positions, which are candidate SSB transmission position 0 to candidate SSB transmission position 7. The first indication information consists of M1=7 bits, and the second indication information consists of M2=3 bits. Specifically, the first indication information indicates, with a 7-bit bitmap, a number of SSBs and position indexes of the SSBs actually transmitted at 7 candidate SSB transmission positions after a candidate SSB transmission position at which a first SSB actually transmitted is located, and the second indication information indicates, with 3 bits, that the first SSB actually transmitted is located at a k-th candidate SSB transmission position in the first SSB group.

It should be noted that the first indication information indicates, with the 7-bit bitmap, the number of the SSBs and the position indexes of the SSBs actually transmitted at the 7 candidate SSB transmission positions after the candidate SSB transmission position at which the first SSB actually transmitted by the base station is located. For example, when the 7-bit bitmap is set to “1110001”, an SSB transmission situation at the 7 candidate SSB transmission positions after the candidate SSB transmission position at which the first SSB actually transmitted by the base station is located is as follows: first, there are SSB transmissions at three continuous candidate SSB transmission positions, then there are no SSB transmissions at three candidate SSB transmission positions, and then there is a further SSB transmission at a candidate SSB transmission position.

In the implementation four, the first SSB group is an SSB group in which the first SSB actually transmitted is located.

Optionally, the first SSB group may be indicated by a base station. For example, the base station may send third indication information indicating the first SSB group to the UE through one of broadcasting, DCI, or RRC signaling.

Optionally, the first SSB group may also be determined by the UE based on a detected SSB index. Specifically, as shown in FIG. 6, the first SSB group is SSB group 1.

It should be noted that from which SSB group the base station starts to transmit an SSB depends on a configuration of the base station. For example, in an unlicensed frequency band, the base station may transmit an SSB at a first candidate SSB transmission position after obtaining an available channel.

Specifically, as shown in FIG. 6, M2=011, which indicates that the first SSB actually transmitted is located at a 4th candidate SSB transmission position in SSB group 1, i.e., k=4, and a corresponding SSB position index is 11.

It should be noted that 000 corresponds to k being 1, 001 corresponds to k being 2, and so on, and 111 corresponds to k being 8.

Specifically, as shown in FIG. 6, M1=1110001, and the first indication information indicates, with a 7-bit bitmap, that the number of the SSBs actually transmitted at 7 candidate SSB transmission positions after the candidate SSB transmission position at which the first SSB actually transmitted is located is 4, and the position indexes of the SSBs are 12, 13, 14 and 18.

Optionally, in the implementation four, the UE may determine, just based on M1 and M2, positions of SSBs actually transmitted by the base station within the first transmission window.

Optionally, as an implementation five, the first transmission window includes four SSB groups, which are SSB group 0 to SSB group 3 as shown in FIG. 7. Each SSB group includes 8 candidate SSB transmission positions, which are candidate SSB transmission position 0 to candidate SSB transmission position 7. The first indication information consists of M1=3 bits, and the second indication information consists of M2=3 bits. Specifically, the first indication information indicates a number of SSBs actually transmitted with 3 bits, and the SSBs actually transmitted occupy continuous candidate SSB transmission positions, and the second indication information indicates, with 3 bits, that the first SSB actually transmitted is located at a k-th candidate SSB transmission position in the first SSB group.

Optionally, M1=log₂ X, i.e., M1=log₂ 8=3. Optionally, M2=log₂ N2, i.e., M2=log₂ 8=3.

In the implementation five, the first SSB group is an SSB group in which the first SSB actually transmitted is located.

Optionally, the first SSB group may be indicated by a base station. For example, the base station may send third indication information indicating the first SSB group to the UE through one of broadcasting, DCI, or RRC signaling. Optionally, the first SSB group may also be determined by the UE based on a detected SSB index. Specifically, as shown in FIG. 7, the first SSB group is SSB group 1.

It should be noted that from which SSB group the base station starts to transmit an SSB depends on a configuration of the base station. For example, in an unlicensed frequency band, the base station may transmit an SSB at a first candidate SSB transmission position after obtaining an available channel.

Specifically, as shown in FIG. 7, M2=100, which indicates that the first SSB actually transmitted is located at a 4th candidate SSB transmission position in SSB group 1, i.e., k=5, and a corresponding SSB position index is 12.

It should be noted that 000 corresponds to k being 1, 001 corresponds to k being 2, and so on, and 111 corresponds to k being 8.

Specifically, as shown in FIG. 7, M1=011, and the first indication information indicates, with 3 bits, that the number of the SSBs actually transmitted is 4, and the indexes of continuous candidate SSB transmission positions occupied by the SSBs actually transmitted are 12 to 15.

Optionally, in the implementation five, the UE may determine, just based on M1 and M2, positions of SSBs actually transmitted by the base station within the first transmission window.

Optionally, as an implementation six, the first transmission window includes four SSB groups, which are SSB group 0 to SSB group 3 as shown in FIG. 8. Each SSB group includes 8 candidate SSB transmission positions, which are candidate SSB transmission position 0 to candidate SSB transmission position 7. The first indication information consists of M1=7 bits, and the second indication information consists of M2=7 bits. Specifically, the first indication information indicates, with a 7-bit bitmap, a number of SSBs and position indexes of the SSBs actually transmitted at 7 candidate SSB transmission positions before a candidate SSB transmission position at which an SSB currently transmitted is located, and the second indication information indicates, with a 7-bit bitmap, a number of SSBs and position indexes of the SSBs actually transmitted at 7 candidate SSB transmission positions after the candidate SSB transmission position at which the SSB currently transmitted is located. Optionally, M1=M2=N2−1.

It should be noted that the first indication information indicates, with the 7-bit bitmap, the number of the SSBs and the position indexes of the SSBs actually transmitted at the 7 candidate SSB transmission positions before the SSB currently transmitted. For example, when the 7-bit bitmap is set to “0000111”, an SSB transmission situation at the 7 candidate SSB transmission positions before the current SSB transmission position is as follows: first, there are no SSB transmissions at four continuous candidate SSB transmission positions, and then there are SSB transmissions at three candidate SSB transmission positions. Similarly, the second indication information indicates, with the 7-bit bitmap, the number of the SSBs and the position indexes of the SSBs actually transmitted at the 7 candidate SSB transmission positions after the SSB currently transmitted. For example, when the 7-bit bitmap is set to “1110000”, an SSB transmission situation at the 7 candidate SSB transmission positions after the current SSB transmission position is as follows: first, there are SSB transmissions at three continuous candidate SSB transmission positions, and then there are no SSB transmissions at four candidate SSB positions.

It should be noted that from which SSB group the base station starts to transmit an SSB depends on a configuration of the base station. For example, in an unlicensed frequency band, the base station may transmit an SSB at a first candidate SSB transmission position after obtaining an available channel.

Specifically, as shown in FIG. 8, the UE detects that the index of the SSB currently transmitted is 14, the M1=0000111 bitmap indicates that the number of the SSBs actually transmitted at the 7 candidate SSB transmission positions before the candidate SSB transmission position at which the SSB currently transmitted is located is 3, and the position indexes of the SSBs are 11, 12 and 13; and the M2=1110000 bitmap indicates that the number of the SSBs actually transmitted at the 7 candidate SSB transmission positions after the candidate SSB transmission position at which the SSB currently transmitted is located is 3, and the position indexes of the SSBs are 15, 16 and 17.

Optionally, in the implementation six, the UE may determine, just based on M1 and M2, positions of SSBs actually transmitted by the base station within the first transmission window.

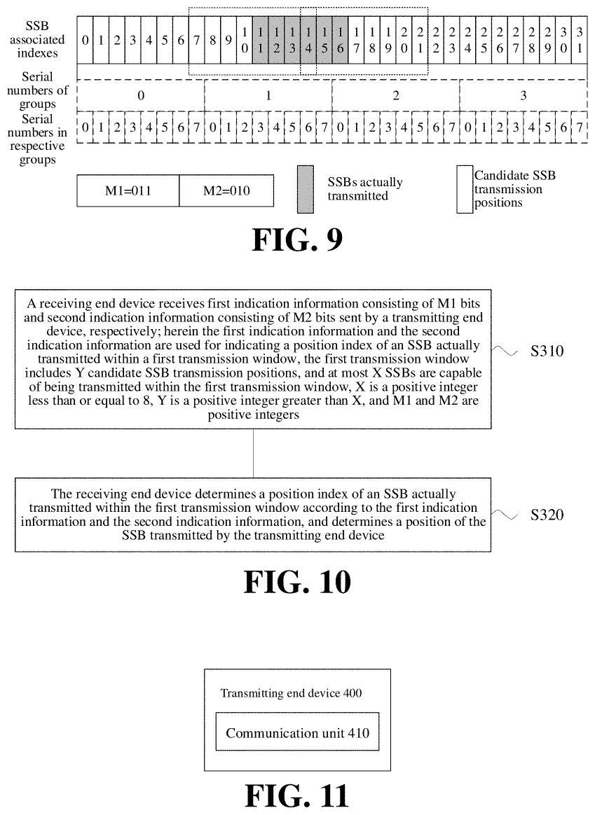

Optionally, as an implementation seven, the first transmission window includes four SSB groups, which are SSB group 0 to SSB group 3 as shown in FIG. 9. Each SSB group includes 8 candidate SSB transmission positions, which are candidate SSB transmission position 0 to candidate SSB transmission position 7. The first indication information consists of M1=3 bits, and the second indication information consists of M2=3 bits. Specifically, the first indication information indicates a number of SSBs continuously transmitted before an candidate SSB transmission position at which an SSB currently transmitted is located with 3 bits, including the SSB currently transmitted, and the second indication information indicates a number of SSBs continuously transmitted after the candidate SSB transmission position at which the SSB currently transmitted is located with 3 bits, including the SSB currently transmitted. Optionally, M1=M2=log₂ X=log₂ 8=3.

It should be noted that from which SSB group the base station starts to transmit an SSB depends on a configuration of the base station. For example, in an unlicensed frequency band, the base station may transmit an SSB at a first candidate SSB transmission position after obtaining an available channel.

Specifically, as shown in FIG. 9, the UE detects that the index of the SSB currently transmitted is 14, and M1=011 indicates that the number of SSBs continuously transmitted before the candidate SSB transmission position at which the SSB currently transmitted is located, including the SSB currently transmitted is 4, that is, M1 indicates that the position indexes of the SSBs transmitted are 11 to 14; M2=010 indicates that the number of SSBs continuously transmitted after the candidate SSB transmission position at which the SSB currently transmitted is located, including the SSB currently transmitted is 3, that is, M2 indicates that the position indexes of the SSBs transmitted are 14 to 16.

Optionally, in the implementation seven, the UE may determine, just based on M1 and M2, positions of SSBs actually transmitted by the base station within the first transmission window.

It should be understood that in the implementations of the present disclosure, operations such as rate matching may be performed after the receiving end device knows an actual transmission position of an SSB, or after the receiving end device receives an SSB.

Therefore, in the implementations of the present disclosure, the transmitting end device may use a small bitmap to indicate a position of an SSB actually transmitted within a transmission window of a DRS for the receiving end device to perform rate matching, etc.

FIG. 10 is a schematic flow chart of a signal transmission method 300 according to an implementation of the present disclosure. As shown in FIG. 10, the method 300 may include acts S310 and S320.

In act S310, a receiving end device receives first indication information consisting of M1 bits and second indication information consisting of M2 bits sent by a transmitting end device, respectively. The first indication information and the second indication information are used for indicating a position index of an SSB actually transmitted within a first transmission window, herein the first transmission window includes Y candidate SSB transmission positions, and at most X SSBs are capable of being transmitted within the first transmission window, X is a positive integer less than or equal to 8, Y is a positive integer greater than X, and M1 and M2 are positive integers.

In act S320, the receiving end device determines the position index of the SSB actually transmitted within the first transmission window according to the first indication information and the second indication information, and determines the position of the SSB transmitted by the transmitting end device.

Optionally, the receiving end device may be a terminal device, and the transmitting end device may be a network device.

Optionally, in an implementation of the present disclosure, the first transmission window is a discovery reference signal transmission window, and the first transmission window is one of at least one discovery reference signal transmission window in one discovery reference signal period.

Optionally, the Y candidate SSB transmission positions are divided into N1 SSB groups, and each SSB group includes N2 candidate SSB transmission positions, N1 and N2 being positive integers.

Optionally, in an implementation of the present disclosure, the transmitting end device may directly indicate an SSB group in which a first SSB actually transmitted is located. Preferably, the receiving end device receives third indication information consisting of M3 bits sent by the transmitting end device. The third indication information is used for indicating a first SSB group. The first SSB group is an SSB group in which the first SSB actually transmitted is located. At this time, the receiving end device may determine, based on the third indication information, from which SSB group the transmitting end device starts to transmit an SSB.

Specifically, the transmitting end device sends the third indication information to the receiving end device through one of broadcasting, DCI, or RRC signaling

For example, the transmitting end device sends the third indication information to the receiving end device through a broadcast SIB1, i.e., the third indication information is carried in the SIB1.

Optionally, M3=log₂ N1 or M3=┌log₂N1┐, wherein ┌ ┐ means rounding up.

Optionally, in an implementation of the present disclosure, the receiving end device may also determine, based on a detected SSB index, from which SSB group the transmitting end device starts to transmit an SSB.

Optionally, in an implementation of the present disclosure, the first indication information and the second indication information may specifically indicate a position index of an SSB actually transmitted within the first transmission window in a mode of the following examples.

Example one: the first indication information indicates, with an M1-bit bitmap, a number of SSBs and position indexes of the SSBs actually transmitted in the first SSB group and the second SSB group, and the second indication information indicates, with M2 bits, that the first SSB actually transmitted is located at a k-th candidate SSB transmission position in the first SSB group. The second SSB group is a next group of the first SSB group, and k is a positive integer less than or equal to N2.

Optionally, in the example one, if M1=N2, the first indication information specifically indicates, with an M1-bit bitmap, a number of SSBs and position indexes of the SSBs actually transmitted at a k-th to an N2-th candidate SSB transmission positions in the first SSB group, and indicates a number of SSBs and position indexes of the SSBs actually transmitted at a first to a (k−1)-th candidate SSB transmission positions in the second SSB group.

Further, in the example one, if M1=N2, the first indication information specifically indicates the number of the SSBs and the position indexes of the SSBs actually transmitted at the k-th to the N2-th candidate SSB transmission positions in the first SSB group with a k-th to an M1-th bits in the M1-bit bitmap, and indicates the number of the SSBs and the position indexes of the SSBs actually transmitted at the first to the k−1-th candidate SSB transmission positions in the second SSB group with a first to a (k−1)-th bits in the M1-bit bitmap.

Furthermore, in the example one, if M1=N2 and k=1, the first indication information specifically indicates the number of the SSBs and the position indexes of the SSBs actually transmitted at the first to the N2-th candidate SSB transmission positions in the first SSB group with the first to the M1-th bits in the M1-bit bitmap.

Optionally, in the example one, if M1=N2−1, the first indication information includes a first subsection and a second subsection. The first subsection consists of a k-th to an M1-th bits in the first indication information, and the second subsection consists of a first to a (k−1)-th bits in the first indication information. A bitmap of the first subsection indicates a number of SSBs and position indexes of the SSBs actually transmitted at a (k+1)-th to an N2-th candidate SSB transmission positions in the first SSB group, and a bitmap of the second subsection indicates a number of SSBs and position indexes of the SSBs actually transmitted at a first to a (k−1)-th candidate SSB transmission positions in the second SSB group.

Further, in the example one, if M1=N2−1 and k=1, the bitmap of the first subsection specifically indicates the number of the SSBs and the position indexes of the SSBs actually transmitted at the second to the N2-th candidate SSB transmission positions in the first SSB group.

Optionally, in the example one, M2=log₂ N2. Optionally, in the example one, the first SSB group is indicated by the third indication information. Optionally, in the example one, the receiving end device may determine the first SSB group based on a detected SSB index.

Example two: the first indication information indicates, with an M1-bit bitmap, a number of SSBs and position indexes of the SSBs actually transmitted at M1 candidate SSB transmission positions starting from a candidate SSB transmission position at which a first SSB actually transmitted is located, and the second indication information indicates, with M2 bits, that the first SSB actually transmitted is located at a k-th candidate SSB transmission position in the first SSB group, M1=N2 and k being a positive integer less than or equal to N2.

Optionally, in the example two, M2=log₂ N2. Optionally, in the example two, the first SSB group is indicated by the third indication information. Optionally, in the example two, the receiving end device may determine the first SSB group based on a detected SSB index.

Example three: the first indication information indicates, with an M1-bit bitmap, a number of SSBs and position indexes of the SSBs actually transmitted at M1 candidate SSB transmission positions after a candidate SSB transmission position at which a first SSB actually transmitted is located, and the second indication information indicates, with M2 bits, that the first SSB actually transmitted is located at a k-th candidate SSB transmission position in the first SSB group, M1=N2−1 and k being a positive integer less than or equal to N2.

Optionally, in the example three, M2=log₂ N2. Optionally, in the example three, the first SSB group is indicated by the third indication information. Optionally, in the example three, the receiving end device may determine the first SSB group based on a detected SSB index.

Example four: the first indication information indicates a number of SSBs actually transmitted with M1 bits, and the SSBs actually transmitted occupy continuous candidate SSB transmission positions; and the second indication information indicates, with M2 bits, that the first SSB actually transmitted is located at a k-th candidate SSB transmission position in the first SSB group, k being a positive integer less than or equal to N2.

Optionally, in the example four, M1=log₂ X. Optionally, in the example four, M2=log₂ N2.

Optionally, in the example four, the first SSB group is indicated by the third indication information.

Optionally, in the example four, the receiving end device may determine the first SSB group based on a detected SSB index.

Example five: the first indication information indicates, with an M1-bit bitmap, a number of SSBs and position indexes of the SSBs actually transmitted at M1 candidate SSB transmission positions before a candidate SSB transmission position at which an SSB currently transmitted is located, and the second indication information indicates, with an M2-bit bitmap, a number of SSBs and position indexes of the SSBs actually transmitted at M2 candidate SSB transmission positions after the candidate SSB transmission position at which the SSB currently transmitted is located. Optionally, in the example five, M1=M2=N2−1. It should be noted that in the example five, the receiving end device may detect the SSB currently transmitted.

Example six: the first indication information indicates a number of SSBs continuously transmitted before a candidate SSB transmission position at which an SSB currently transmitted is located with M1 bits, including the SSB currently transmitted; and the second indication information indicates a number of SSBs continuously transmitted after the candidate SSB transmission position at which the SSB currently transmitted is located with M2 bits, including the SSB currently transmitted.

Optionally, in the example six, M1=M2=log₂ X. It should be noted that in the example six, the receiving end device may detect the SSB currently transmitted.

Optionally, in an implementation of the present disclosure, the values of Y, N1 and N2 may be as follows:

Y is 16, N1 is 4, and N2 is 4; or Y is 16, N1 is 2, and N2 is 8; or Y is 32, N1 is 8, and N2 is 4; or Y is 32, N1 is 4, and N2 is 8; or Y is 32, N1 is 2, and N2 is 16; or Y is 64, N1 is 16, and N2 is 4; or Y is 64, N1 is 8, and N2 is 8; or Y is 64, N1 is 4, and N2 is 16; or Y is 64, N1 is 2, and N2 is 32.

Optionally, in an implementation of the present disclosure, X is 8, or X is 4.

Optionally, in an implementation of the present disclosure, the transmitting end device may send the first indication information to the receiving end device through one of broadcasting, DCI, or RRC signaling. For example, the receiving end device receives the first indication information sent by the transmitting end device through the broadcast SIB1.

Optionally, in an implementation of the present disclosure, the transmitting end device may send the second indication information to the receiving end device through one of broadcasting, DCI, or RRC signaling. For example, the receiving end device receives the second indication information sent by the transmitting end device through the broadcast SIB1.

Optionally, in an implementation of the present disclosure, the first indication information and the second indication information may be integrated in one piece of information for transmission, for example, through the broadcast SIB1. Optionally, in an implementation of the present disclosure, the second indication information and the third indication information may be integrated in one piece of information for transmission, for example, through DCI. Optionally, in an implementation of the present disclosure, the first indication information, the second indication information and the third indication information may be integrated in one piece of information for transmission, and the transmission mode may be any one of broadcasting, DCI, or RRC signaling.

It should be understood that acts in the signal transmission method 300 may be referred to the corresponding acts in the signal transmission method 200, which will not be repeated here for brevity.

FIG. 11 is a schematic block diagram of a transmitting end device 400 according to an implementation of the present disclosure. As shown in FIG. 11, the transmitting end device 400 includes a communication unit 410 configured to send first indication information consisting of M1 bits and second indication information consisting of M2 bits to a receiving end device, respectively. The first indication information and the second indication information are used for indicating a position index of an SSB actually transmitted within a first transmission window, herein the first transmission window includes Y candidate SSB transmission positions, and at most X SSBs are capable of being transmitted within the first transmission window, X is a positive integer less than or equal to 8, Y is a positive integer greater than X, and M1 and M2 are positive integers.

Optionally, the Y candidate SSB transmission positions are divided into N1 SSB groups, and each SSB group includes N2 candidate SSB transmission positions, N1 and N2 being positive integers.

Optionally, the communication unit 410 is further configured to send third indication information consisting of M3 bits to the receiving end device. The third indication information is used for indicating a first SSB group. The first SSB group is an SSB group in which a first SSB actually transmitted is located.

Optionally, the first indication information indicates, with an M1-bit bitmap, a number of SSBs and position indexes of the SSBs actually transmitted in the first SSB group and the second SSB group, and the second indication information indicates, with M2 bits, that a first SSB actually transmitted is located at a k-th candidate SSB transmission position in the first SSB group. The second SSB group is a next group of the first SSB group, and k is a positive integer less than or equal to N2.

Optionally, M1=N2, the first indication information specifically indicates, with an M1-bit bitmap, a number of SSBs and position indexes of the SSBs actually transmitted at a k-th to an N2-th candidate SSB transmission positions in the first SSB group, and indicates a number of SSBs and position indexes of the SSBs actually transmitted at a first to a (k−1)-th candidate SSB transmission positions in the second SSB group.

Optionally, the first indication information specifically indicates the number of the SSBs and the position indexes of the SSBs actually transmitted at the k-th to the N2-th candidate SSB transmission positions in the first SSB group with a k-th to an M1-th bits in the M1-bit bitmap, and indicates the number of the SSBs and the position indexes of the SSBs actually transmitted at the first to the (k−1)-th candidate SSB transmission positions in the second SSB group with a first to a (k−1)-th bits in the M1-bit bitmap.

Optionally, if k=1, the first indication information specifically indicates the number of the SSBs and the position indexes of the SSBs actually transmitted at the first to the N2-th candidate SSB transmission positions in the first SSB group with the first to the M1-th bits in the M1-bit bitmap.

Optionally, M1=N2−1, and the first indication information includes a first subsection and a second subsection. The first subsection consists of a k-th to an M1-th bits in the first indication information, and the second subsection consists of a first to a (k−1)-th bits in the first indication information. A bitmap of the first subsection indicates a number of SSBs and position indexes of the SSBs actually transmitted at a (k+1)-th to an N2-th candidate SSB transmission positions in the first SSB group; and a bitmap of the second subsection indicates a number of SSBs and position indexes of the SSBs actually transmitted at a first to a (k−1)-th candidate SSB transmission positions in the second SSB group.

Optionally, if k=1, the bitmap of the first subsection specifically indicates the number of SSBs and the position indexes of the SSBs actually transmitted at the second to the N2-th candidate SSB transmission positions in the first SSB group.

Optionally, the first indication information indicates, with an M1-bit bitmap, a number of SSBs and position indexes of the SSBs actually transmitted at M1 candidate SSB transmission positions starting from a candidate SSB transmission position at which a first SSB actually transmitted is located; and the second indication information indicates, with M2 bits, that the first SSB actually transmitted is located at a k-th candidate SSB transmission position in the first SSB group, M1=N2 and k being a positive integer less than or equal to N2.

Optionally, the first indication information indicates, with an M1-bit bitmap, a number of SSBs and position indexes of the SSBs actually transmitted at M1 candidate SSB transmission positions after a candidate SSB transmission position at which a first SSB actually transmitted is located, and the second indication information indicates, with M2 bits, that the first SSB actually transmitted is located at the k-th candidate SSB transmission position in the first SSB group, M1=N2−1 and k being a positive integer less than or equal to N2.

Optionally, the first indication information indicates a number of SSBs actually transmitted with M1 bits, and the SSBs actually transmitted occupy continuous candidate SSB transmission positions; and the second indication information indicates, with M2 bits, that the first SSB actually transmitted is located at the k-th candidate SSB transmission position in the SSB group currently transmitted, k being a positive integer less than or equal to N2.

Optionally, M1=log₂ X. Optionally, M2=log₂ N2. Optionally, M3=log₂ N1 or M3=┌log₂ N1┐.

Optionally, the communication unit 410 is specifically configured to send the third indication information to the receiving end device through one of broadcasting, DCI, or RRC signaling.

Optionally, the first indication information indicates, with an M1-bit bitmap, a number of SSBs and position indexes of the SSBs actually transmitted at M1 candidate SSB transmission positions before a candidate SSB transmission position at which an SSB currently transmitted is located, and the second indication information indicates, with an M2-bit bitmap, a number of SSBs and position indexes of the SSBs actually transmitted at M2 candidate SSB transmission positions after the candidate SSB transmission position at which the SSB currently transmitted is located. Optionally, M1=M2=N2−1.

Optionally, the first indication information indicates a number of SSBs continuously transmitted before a candidate SSB transmission position at which an SSB currently transmitted is located with M1 bits, including the SSB currently transmitted; and the second indication information indicates a number of SSBs continuously transmitted after the candidate SSB transmission position at which the SSB currently transmitted is located with M2 bits, including the SSB currently transmitted. Optionally, M1=M2=log₂ X.

Optionally, Y is 16, N1 is 4, and N2 is 4; or Y is 16, N1 is 2, and N2 is 8; or Y is 32, N1 is 8, and N2 is 4; or Y is 32, N1 is 4, and N2 is 8; or Y is 32, N1 is 2, and N2 is 16; or Y is 64, N1 is 16, and N2 is 4; or Y is 64, N1 is 8, and N2 is 8; or Y is 64, N1 is 4, and N2 is 16; or Y is 64, N1 is 2, and N2 is 32. Optionally, X is 8, or X is 4.

Optionally, the first transmission window is a discovery reference signal transmission window, and the first transmission window is one of at least one discovery reference signal transmission window in one discovery reference signal period.

Optionally, the communication unit 410 is specifically configured to send the first indication information to the receiving end device through one of broadcasting, DCI, or RRC signaling. Optionally, the communication unit 410 is specifically configured to send the second indication information to the receiving end device through one of broadcasting, DCI, or RRC signaling. Optionally, the transmitting end device 400 is a network device.

It should be understood that the transmitting end device 400 according to an implementation of the present disclosure may correspond to the transmitting end device in the method implementation of the present disclosure, and the above and other operations and/or functions of various units in the transmitting end device 400 are respectively for implementing the corresponding flows of the transmitting end device in the method 200 shown in FIG. 2, which will not be repeated here for the sake of brevity.

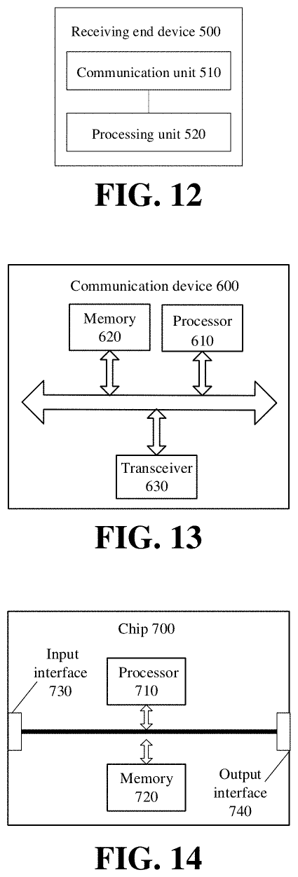

FIG. 12 is a schematic block diagram of a receiving end device 500 according to an implementation of the present disclosure. As shown in FIG. 12, the receiving end device 500 includes a communication unit 510 and a processing unit 520.

The communication unit 510 is configured to receive first indication information consisting of M1 bits and second indication information consisting of M2 bits sent by a transmitting end device, respectively. The first indication information and the second indication information are used for indicating a position index of a Synchronization Signal Block (SSB) actually transmitted within a first transmission window, herein the first transmission window includes Y candidate SSB transmission positions, and at most X SSBs are capable of being transmitted within the first transmission window, X is a positive integer less than or equal to 8, Y is a positive integer greater than X, and M1 and M2 are positive integers.

The processing unit 520 is configured to determine the position index of the SSB actually transmitted within the first transmission window according to the first indication information and the second indication information, and determine a position of the SSB transmitted by the transmitting end device.

Optionally, the Y candidate SSB transmission positions are divided into N1 SSB groups, and each SSB group includes N2 candidate SSB transmission positions, N1 and N2 being positive integers.

Optionally, the communication unit is further configured to receive third indication information consisting of M3 bits sent by the transmitting end device. The third indication information is used for indicating a first SSB group. Herein, the first SSB group is an SSB group in which a first SSB actually transmitted is located.

The processing unit 520 is specifically configured to determine position indexes of SSBs actually transmitted within the first transmission window according to the first indication information, the second indication information and the third indication information.

Optionally, the first indication information indicates, with an M1-bit bitmap, a number of SSBs and position indexes of the SSBs actually transmitted in the first SSB group and the second SSB group, and the second indication information indicates, with M2 bits, that the first SSB actually transmitted is located at a k-th candidate SSB transmission position in the first SSB group. The second SSB group is a next group of the first SSB group, and k is a positive integer less than or equal to N2.

Optionally, M1=N2, the first indication information specifically indicates, with an M1-bit bitmap, a number of SSBs and position indexes of the SSBs actually transmitted at a k-th to an N2-th candidate SSB transmission positions in the first SSB group, and indicates the number of SSBs and position indexes of the SSBs actually transmitted at a first to a (k−1)-th candidate SSB transmission positions in the second SSB group.

Optionally, the first indication information specifically indicates the number of the SSBs and the position indexes of the SSBs actually transmitted at the k-th to the N2-th candidate SSB transmission positions in the first SSB group with a k-th to an M1-th bits in the M1-bit bitmap, and indicates the number of the SSBs and the position indexes of the SSBs actually transmitted at the first to the (k−1)-th candidate SSB transmission positions in the second SSB group with a first to a (k−1)-th bits in the M1-bit bitmap.

Optionally, if k=1, the first indication information specifically indicates, with the first to the M1-th bits in the M1-bit bitmap, the number of the SSBs and the position indexes of the SSBs actually transmitted at the first to the N2-th candidate SSB transmission positions in the first SSB group.

Optionally, M1=N2−1, the first indication information includes a first subsection and a second subsection. The first subsection consists of a k-th to an M1-th bits in the first indication information, and the second subsection consists of a first to a (k−1)-th bits in the first indication information. A bitmap of the first subsection indicates a number of SSBs and position indexes of the SSBs actually transmitted at a (k+1)-th to an N2-th candidate SSB transmission positions in the first SSB group, and a bitmap of the second subsection indicates a number of SSBs and position indexes of the SSBs actually transmitted at a first to a (k−1)-th candidate SSB transmission positions in the second SSB group.

Optionally, if k=1, the bitmap of the first subsection specifically indicates the number of the SSBs and the position indexes of the SSBs actually transmitted at the second to the N2-th candidate SSB transmission positions in the first SSB group.

Optionally, the first indication information indicates a number of SSBs and position indexes of the SSBs actually transmitted at M1 candidate SSB transmission positions starting from a candidate SSB transmission position at which a first SSB actually transmitted is located with an M1-bit bitmap, and the second indication information indicates that the first SSB actually transmitted is located at a k-th candidate SSB transmission position in the first SSB group with M2 bits, k being a positive integer less than or equal to N2.

Optionally, the first indication information indicates a number of SSBs and position indexes of the SSBs actually transmitted at M1 candidate SSB transmission positions after a candidate SSB transmission position at which a first SSB actually transmitted is located with an M1-bit bitmap, and the second indication information indicates, with M2 bits, that the first SSB actually transmitted is located at a k-th candidate SSB transmission position in the first SSB group, M1=N2−1 and k being a positive integer less than or equal to N2.

Optionally, the first indication information indicates a number of SSBs actually transmitted with M1 bits, and the SSBs actually transmitted occupy continuous candidate SSB transmission positions; and the second indication information indicates, with M2 bits, that the first SSB actually transmitted is located at a k-th candidate SSB transmission position in the first SSB group, k being a positive integer less than or equal to N2.

Optionally, M1=log₂ X. Optionally, M2=log₂ N2. Optionally, M3=log₂ N1 or M3=┌log₂ N1┐.

Optionally, the communication unit 510 is specifically configured to receive the third indication information sent by the transmitting end device through one of broadcasting, DCI and RRC signaling.

Optionally, the first indication information indicates a number of SSBs and position indexes of the SSBs actually transmitted at M1 candidate SSB transmission positions before a candidate SSB transmission position at which an SSB currently transmitted is located with an M1-bit bitmap, and the second indication information indicates a number of SSBs and position indexes of the SSBs actually transmitted at M2 candidate SSB transmission positions after the candidate SSB transmission position at which the SSB currently transmitted is located with an M2-bit bitmap. Optionally, M1=M2=N2−1.

Optionally, the first indication information indicates a number of SSBs continuously transmitted before a candidate SSB transmission position at which an SSB currently transmitted is located with M1 bits, including the SSB currently transmitted; and the second indication information indicates a number of SSBs continuously transmitted after the candidate SSB transmission position at which the SSB currently transmitted is located with M2 bits, including the SSB currently transmitted. Optionally, M1=M2=log₂ X.

Optionally, Y is 16, N1 is 4, and N2 is 4; or Y is 16, N1 is 2, and N2 is 8; or Y is 32, N1 is 8, and N2 is 4; or Y is 32, N1 is 4, and N2 is 8; or Y is 32, N1 is 2, and N2 is 16; or Y is 64, N1 is 16, and N2 is 4; or Y is 64, N1 is 8, and N2 is 8; or Y is 64, N1 is 4, and N2 is 16; or Y is 64, N1 is 2, and N2 is 32.

Optionally, X is 8, or X is 4.

Optionally, the first transmission window is a discovery reference signal transmission window, and the first transmission window is one of at least one discovery reference signal transmission window in one discovery reference signal period.

Optionally, the communication unit 510 is specifically configured to receive the first information sent by the transmitting end device through one of broadcasting, DCI, or RRC signaling. Optionally, the communication unit 510 is specifically configured to receive the second information sent by the transmitting end device through one of broadcasting, DCI, or RRC signaling. Optionally, the receiving end device 500 is a terminal device.

It should be understood that the receiving end device 500 according to an implementation of the present disclosure may correspond to the receiving end device in the method implementation of the present disclosure, and the above and other operations and/or functions of various units in the receiving end device 500 are respectively for implementing corresponding flows of the receiving end device in the method 300 shown in FIG. 10, which will not be repeated here for brevity.

FIG. 13 is a schematic structural diagram of a communication device 600 according to an implementation of the present disclosure. The communication device 600 shown in FIG. 13 includes a processor 610. The processor 610 may call and run a computer program from a memory to implement the method in an implementation of the present disclosure.

Optionally, as shown in FIG. 13, the communication device 600 may further include a memory 620. The processor 610 may call and run a computer program from the memory 620 to implement the method in an implementation of the present disclosure.

Herein, the memory 620 may be a separate device independent of the processor 610 or may be integrated in the processor 610.

Optionally, as shown in FIG. 13, the communication device 600 may further include a transceiver 630, and the processor 610 may control the transceiver 630 to communicate with other devices. Specifically, the transceiver 630 may send information or data to other devices or receive information or data sent by other devices.

Herein, the transceiver 630 may include a transmitter and a receiver. The transceiver 630 may further include an antenna, and a quantity of antennas may be one or more.

Optionally, the communication device 600 may be specifically a transmitting end device of an implementation of the present disclosure, and the communication device 600 may implement corresponding flows implemented by the transmitting end device in various methods of the implementations of the present disclosure, which will not be repeated here for brevity.

Optionally, the communication device 600 may be specifically a receiving end device of an implementation of the present disclosure, and the communication device 600 may implement corresponding flows implemented by the receiving end device in various methods of the implementations of the present disclosure, which will not be repeated here for brevity.

FIG. 14 is a schematic diagram of a structure of a chip according to an implementation of the present disclosure. A chip 700 shown in FIG. 14 includes a processor 710. The processor 710 may call and run a computer program from a memory to implement the methods in the implementations of the present disclosure.

Optionally, as shown in FIG. 14, the chip 700 may further include a memory 720. The processor 710 may call and run a computer program from the memory 720 to implement the methods in the implementations of the present disclosure.

Herein, the memory 720 may be a separate device independent of the processor 710 or may be integrated in the processor 710.

Optionally, the chip 700 may further include an input interface 730. The processor 710 may control the input interface 730 to communicate with other device or chip, and specifically, may acquire information or data sent by other device or chip.

Optionally, the chip 700 may further include an output interface 740. The processor 710 may control the output interface 740 to communicate with other device or chip, and specifically, may output information or data to other device or chip.

Optionally, the chip may be applied to a transmitting end device of an implementation of the present disclosure, and the chip may implement corresponding flows implemented by the transmitting end device in various methods of the implementations of the present disclosure, which will not be repeated here for brevity.

Optionally, the chip may be applied to a receiving end device of an implementation of the present disclosure, and the chip may implement corresponding flows implemented by the receiving end device in various methods of the implementations of the present disclosure, which will not be repeated here for brevity.

It should be understood that the chip mentioned in the implementations of the present disclosure may also be referred to as a system-level chip, a system chip, a chip system or a system-on-chip, etc.

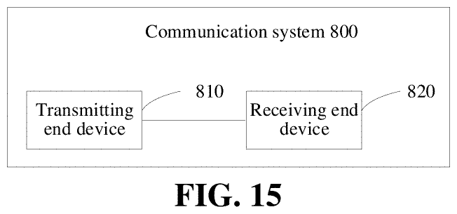

FIG. 15 is a schematic block diagram of a communication system 800 according to an implementation of the present disclosure. As shown in FIG. 15, the communication system 800 includes a transmitting end device 810 and a receiving end device 820.

Herein, the transmitting end device 810 may be configured to implement corresponding functions implemented by the transmitting end device in the above-mentioned methods, and the receiving end device 820 may be configured to implement corresponding functions implemented by the receiving end device in the above-mentioned methods, which will not be repeated here for brevity.

It should be understood that the processor in the implementation of the present disclosure may be an integrated circuit chip having a signal processing capability. In an implementation process, steps of the foregoing method implementations may be implemented by an integrated logic circuit of hardware in the processor or instructions in a form of software. The processor may be a general purpose processor, a Digital Signal Processor (DSP), an Application Specific Integrated Circuit (ASIC), a Field Programmable Gate Array (FPGA) or other programmable logic devices, a discrete gate or a transistor logic device, or a discrete hardware component. The processor may implement or execute methods, acts and logical block diagrams disclosed in the implementations of the present disclosure. The general purpose processor may be a microprocessor, or the processor may be any conventional processor or the like. The acts of the methods disclosed with reference to the implementations of the present disclosure may be directly implemented by a hardware decoding processor, or may be implemented by a combination of hardware and software modules in the decoding processor. The software modules may be located in a storage medium commonly used in the art, such as a random access memory, a flash memory, a read-only memory, a programmable read-only memory or an electrically erasable programmable memory, or a register. The storage medium is located in a memory, and the processor reads the information in the memory and completes the acts of the above methods in combination with its hardware.

It may be understood that the memory in the implementations of the present disclosure may be a transitory memory or a non-transitory memory, or may include both a transitory memory and a non-transitory memory. The non-transitory memory may be a Read-Only Memory (ROM), a Programmable ROM (PROM), an Erasable PROM (EPROM), an Electrically EPROM (EEPROM), or a flash memory. The transitory memory may be a Random Access Memory (RAM) which serves as an external cache. By way of illustrative but not restrictive description, many forms of RAMs are available, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). It should be noted that the memory in the systems and methods described here is intended to include, without being limited to, these and any other suitable types of memory.

It should be understood that the above memory is an example for illustration, but not for limiting. For example, the memory in the implementations of the present disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), a Direct Rambus RAM (DR RAM), or the like. That is, memories in the implementations of the present disclosure are intended to include, without being limited to, these and any other suitable types of memories.

An implementation of the present disclosure further provides a computer readable storage medium for storing a computer program.

Optionally, the computer readable storage medium may be applied to a transmitting end device of an implementation of the present disclosure, and the computer program causes a computer to perform corresponding flows implemented by the transmitting end device in various methods of the implementations of the present disclosure, which will not be repeated here for brevity.

Optionally, the computer readable storage medium may be applied to a receiving end device of an implementation of the present disclosure, and the computer program causes a computer to perform corresponding flows implemented by the receiving end device in various methods of the implementations of the present disclosure, which will not be repeated here for brevity.

An implementation of the present disclosure also provides a computer program product including computer program instructions.

Optionally, the computer program product may be applied to a transmitting end device of an implementation of the present disclosure, and the computer program instructions cause a computer to perform corresponding flows implemented by the transmitting end device in various methods of the implementations of the present disclosure, which will not be repeated here for brevity.

Optionally, the computer program product may be applied to a receiving end device of an implementation of the present disclosure, and the computer program instructions cause a computer to perform corresponding flows implemented by the receiving end device in various methods of the implementations of the present disclosure, which will not be repeated here for brevity.

An implementation of the present disclosure also provides a computer program.

Optionally, the computer program may be applied to a transmitting end device of an implementation of the present disclosure. When being run on a computer, the computer program causes the computer to execute corresponding processes implemented by the transmitting end device in various methods of the implementations of the present disclosure, which will not be repeated here for brevity.

Optionally, the computer program may be applied to a receiving end device of an implementation of the present disclosure. When being run on a computer, the computer program causes the computer to execute corresponding processes implemented by the receiving end device in various methods of the implementations of the present disclosure, which will not be repeated here for brevity.

Those of ordinary skills in the art may recognize that the example units and algorithm steps described in combination with the implementations disclosed herein may be implemented in electronic hardware, or a combination of computer software and electronic hardware. Whether these functions are implemented in hardware or software depends on a specific application and design constraints of the technical solutions. Professional technicians may use different methods to implement the described functions in respect to each particular application, but such implementation should not be considered to be beyond the scope of the present disclosure.

Those skilled in the art may clearly understand that for convenience and conciseness of description, as to specific working processes of the systems, apparatuses and units described above, reference may be made to the corresponding processes in the method implementations, which will not be repeated here.

In several implementations provided by the present disclosure, it should be understood that the disclosed systems, apparatuses and methods may be implemented in other ways. For example, the apparatus implementations described above are only illustrative, for example, the division of the units is only a logical function division, and there may be other division modes in actual implementation, for example, multiple units or components may be combined or integrated into another system, or some features may be ignored or not executed. On the other hand, the displayed or discussed mutual coupling or direct coupling or communication connection may be indirect coupling or communication connection through some interfaces. The indirect couplings or communication connections between apparatuses or units may be in electrical, mechanical or other forms.

The unit described as a separate component may or may not be physically separated, and the component shown as a unit may or may not be a physical unit, i.e., it may be located in one place or may be distributed over multiple network units. Some or all of the units may be selected according to actual needs to achieve the objectives of the solutions of the implementations.

In addition, various functional units in various implementations of the present disclosure may be integrated in one processing unit, or the various units may be physically present separately, or two or more units may be integrated in one unit.

When the functions are implemented in the form of software functional units and sold or used as an independent product, the software functional units may be stored in a computer-readable storage medium. Based on such an understanding, the technical solution of the present disclosure, in essence, or the part contributing to the prior art, or the part of the technical solution, may be embodied in the form of a software product stored in a storage medium. The computer software product is stored in a storage medium and includes several instructions for instructing a computer device (which may be a personal computer, a server, a network device or the like) to perform all or part of the acts of the methods described in various implementations of the present disclosure. The foregoing storage medium includes various mediums capable of storing program codes, such as a USB flash disk, a removable hard disk, a Read-Only Memory (ROM), a Random Access Memory (RAM), a magnetic disk, or an optical disk.

The foregoing descriptions are merely specific implementations of the present disclosure, but are not intended to limit the protection scope of the present disclosure. Any variation or substitution readily conceived by a person skilled in the art within the technical scope disclosed by the present disclosure shall fall within the protection scope of the present disclosure. Therefore, the protection scope of the present disclosure shall be subject to the protection scope of the claims.

What is claimed is:

1. A method for signal transmission, comprising:
receiving, by a receiving end device, first indication information consisting of M1 bits and second indication information consisting of M2 bits sent by a transmitting end device, respectively; wherein the first indication information and the second indication information are used for indicating a position index of a Synchronization Signal Block (SSB) actually transmitted within a first transmission window, the first transmission window comprises Y candidate SSB transmission positions, and at most X SSBs are capable of being transmitted within the first transmission window, X is a positive integer less than or equal to 8, Y is a positive integer greater than X, and M1 and M2 are positive integers; and
determining, by the receiving end device, a position index of an SSB actually transmitted within the first transmission window according to the first indication information and the second indication information, and determining a position of an SSB transmitted by the transmitting end device.

2. The method of claim 1, wherein the Y candidate SSB transmission positions are divided into N1 SSB groups, and each SSB group comprises N2 candidate SSB transmission positions, N1 and N2 being positive integers.

3. The method of claim 2, further comprising:
receiving, by the receiving end device, third indication information consisting of M3 bits sent by the transmitting end device, wherein the third indication information is used for indicating a first SSB group, and the first SSB group is an SSB group in which a first SSB actually transmitted is located;
wherein determining, by the receiving end device, the position index of the SSB actually transmitted within the first transmission window according to the first indication information and the second indication information comprises:
determining, by the receiving end device, the position index of the SSB actually transmitted within the first transmission window according to the first indication information, the second indication information and the third indication information.

4. The method of claim 3, wherein the first indication information indicates, with an M1-bit bitmap, a number of SSBs and position indexes of the SSBs actually transmitted in the first SSB group and a second SSB group, and the second indication information indicates, with M2 bits, that the first SSB actually transmitted is located at a k-th candidate SSB transmission position in the first SSB group, wherein the second SSB group is a next group of the first SSB group, and k is a positive integer less than or equal to N2.

5. The method of claim 3, wherein the first indication information indicates, with an M1-bit bitmap, a number of SSBs and position indexes of the SSBs actually transmitted at M1 candidate SSB transmission positions starting from a candidate SSB transmission position at which the first SSB actually transmitted is located, and the second indication information indicates, with M2 bits, that the first SSB actually transmitted is located at a k-th candidate SSB transmission position in the first SSB group, k being a positive integer less than or equal to N2.

6. The method of claim 3, wherein the first indication information indicates, with an M1-bit bitmap, a number of SSBs and position indexes of the SSBs actually transmitted at M1 candidate SSB transmission positions after a candidate SSB transmission position at which the first SSB actually transmitted is located, and the second indication information indicates, with M2 bits, that the first SSB actually transmitted is located at a k-th candidate SSB transmission position in the first SSB group, M1=N2−1 and k being a positive integer less than or equal to N2.

7. The method of claim 3, wherein the first indication information indicates, with M1 bits, a number of SSBs actually transmitted, and the SSBs actually transmitted occupy continuous candidate SSB transmission positions; and the second indication information indicates, with M2 bits, that the first SSB actually transmitted is located at a k-th candidate SSB transmission position in the first SSB group, k being a positive integer less than or equal to N2.

8. The method of claim 2, wherein the first indication information indicates, with an M1-bit bitmap, a number of SSBs and position indexes of the SSBs actually transmitted at M1 candidate SSB transmission positions before a candidate SSB transmission position at which an SSB currently transmitted is located, and the second indication information indicates, with an M2-bit bitmap, a number of SSBs and position indexes of the SSBs actually transmitted at M2 candidate SSB transmission positions after the candidate SSB transmission position at which the SSB currently transmitted is located.

9. The method of claim 2, wherein the first indication information indicates, with M1 bits, a number of SSBs continuously transmitted before a candidate SSB transmission position at which an SSB currently transmitted is located, comprising the SSB currently transmitted, and the second indication information indicates, with M2 bits, a number of SSBs continuously transmitted after the candidate SSB transmission position at which the SSB currently transmitted is located, comprising the SSB currently transmitted.

10. The method of claim 1, wherein the first transmission window is a discovery reference signal transmission window, and the first transmission window is one of at least one discovery reference signal transmission window within a discovery reference signal period.

11. A receiving end device, comprising a processor and a transceiver; wherein
the transceiver is configured to receive first indication information consisting of M1 bits and second indication information consisting of M2 bits sent by a transmitting end device, respectively; wherein the first indication information and the second indication information are used for indicating a position index of a Synchronization Signal Block (SSB) actually transmitted within a first transmission window, the first transmission window comprises Y candidate SSB transmission positions, and at most X SSBs are capable of being transmitted within the first transmission window, X is a positive integer less than or equal to 8, Y is a positive integer greater than X, and M1 and M2 are positive integers; and
the processor is configured to determine a position index of an SSB actually transmitted within the first transmission window according to the first indication information and the second indication information, and determine a position of the SSB transmitted by the transmitting end device.

12. The receiving end device of claim 11, wherein the Y candidate SSB transmission positions are divided into N1 SSB groups, and each SSB group comprises N2 candidate SSB transmission positions, N1 and N2 being positive integers.

13. The receiving end device of claim 12, wherein the transceiver is further configured to receive third indication information consisting of M3 bits sent by the transmitting end device, wherein the third indication information is used for indicating a first SSB group, and the first SSB group is an SSB group in which a first SSB actually transmitted is located; and
the processor is further configured to:
determine position indexes of the SSBs actually transmitted within the first transmission window according to the first indication information, the second indication information and the third indication information.

14. The receiving end device of claim 13, wherein the first indication information indicates, with an M1-bit bitmap, a number of SSBs and position indexes of the SSBs actually transmitted in the first SSB group and a second SSB group, and the second indication information indicates, with M2 bits, that the first SSB actually transmitted is located at a k-th candidate SSB transmission position in the first SSB group, wherein the second SSB group is a next group of the first SSB group, and k is a positive integer less than or equal to N2.

15. The receiving end device of claim 14, wherein M1=N2, and the first indication information further indicates, with an M1-bit bitmap, a number of SSBs and position indexes of the SSBs actually transmitted at a k-th to an N2-th candidate SSB transmission positions in the first SSB group, and a number of SSBs and position indexes of the SSBs actually transmitted at a first to a (k−1)-th candidate SSB transmission positions in the second SSB group.

16. The receiving end device of claim 15, wherein the first indication information further indicates, with a k-th to an M1-th bits in the M1-bit bitmap, the number of the SSBs and the position indexes of the SSBs actually transmitted at the k-th to the N2-th candidate SSB transmission positions in the first SSB group, and indicates, with a first to a (k−1)-th bits in the M1-bit bitmap, the number of the SSBs and the position indexes of the SSBs actually transmitted at the first to the (k−1)-th candidate SSB transmission positions in the second SSB group.

17. The receiving end device of claim 14, wherein M1=N2−1, the first indication information comprises a first subsection and a second subsection, the first subsection consists of a k-th to an M1-th bits in the first indication information, the second subsection consists of a first to a (k−1)-th bits in the first indication information, wherein a bitmap of the first subsection indicates a number of SSBs and position indexes of the SSBs actually transmitted at a (k+1)-th to an N2-th candidate SSB transmission positions in the first SSB group, and a bitmap of the second subsection indicates a number of SSBs and position indexes of the SSBs actually transmitted at a first to a (k−1)-th candidate SSB transmission positions in the second SSB group.

18. The receiving end device of claim 13, wherein the first indication information indicates, with M1 bits, a number of SSBs actually transmitted, and the SSBs actually transmitted occupy continuous candidate SSB transmission positions, and the second indication information indicates, with M2 bits, that the first SSB actually transmitted is located at a k-th candidate SSB transmission position in the first SSB group, k being a positive integer less than or equal to N2.

19. The receiving end device of claim 18, wherein M1=log₂ X.

20. The receiving end device of claim 13, wherein M2=log₂ N2.

21. The receiving end device of claim 13, wherein M3=log₂ N1 or M3=┌log₂N1┐.
